(19) United States
(12) Patent Application Publication
(10) Pub. No.: US 2011/0314440 A1
(43) Pub. Date: Dec. 22, 2011

(54) METHOD AND SYSTEM FOR DETERMINING PRODUCTIVITY OF A TEAM ASSOCIATED WITH MAINTENANCE AND PRODUCTION SUPPORT OF SOFTWARE

(75) Inventors: Aman Kumar SINGHAL, Bangalore (IN); Amit Arun JAVADEKAR, Pune (IN); Parthasarathy M.A., Bangalore (IN)

(73) Assignee: INFOSYS TECHNOLOGIES LIMITED, Bangalore (IN)

(21) Appl. No.: 12/858,483

(22) Filed: Aug. 18, 2010

(30) Foreign Application Priority Data
Jun. 18, 2010 (IN) 1700/CHE/2010

(51) Int. Cl. G06F 9/44

(52) U.S. Cl. 717/101

(57) ABSTRACT

The present invention provides a method, a system, and a computer program product for determining productivity of a team associated with maintenance and production support of software. The invention enables receiving one or more tickets associated with the software, the number of full time equivalent team-members (FTEs) in the team, and weight corresponding to each predefined parameter. Net ticket-units are determined based on the predefined ticket-unit associated with the tickets. An adjustment factor is determined based on the weight corresponding to each predefined parameter. Adjusted ticket-units are determined based on the net ticket-units and the adjustment factor. The productivity of the team for a predefined time period is generated based on the adjusted ticket-units and the number of FTEs. In a similar manner, the invention enables determining the number of FTEs based on a received productivity and the adjusted ticket-units.

### FIELD OF INVENTION

The present invention relates generally to determining productivity of a team associated with software and, more specifically, to a method and a system for determining productivity of a team and number of full time equivalent team-members associated with maintenance and production support of software.

### BACKGROUND

Typically, no software is completely free from bugs. Therefore, it becomes extremely critical that revision and maintenance of software is regularly performed to keep it operational. In addition to revision and maintenance work, a range of diverse activities associated with the software need to be performed. These are production support activities associated with the software that are defined essentially by tickets or instances of user generated requests. Maintenance and production support of software thus includes a diverse variety of activities such as creation and/or deletion of a user from a database, resetting of the passwords, application restart, and ad-hoc reports generation. Generally, these activities are governed by a Service Level Agreement (SLA) between a contracting company and an Information Technology (IT) company. The SLA defines the scope of the activities that need to be performed by the IT company under the purview of maintenance and production support of software. The IT company accordingly deploys a support team for performing maintenance and production support of the software. The support team includes a number of full time equivalent team-members (FTEs) working collectively to complete all user generated requests associated with the software.

The IT company determines the productivity of each support team working on the maintenance and production support of one or more software to track the efficiency of the support teams. The productivity of the support team is generally measured in terms of the number of tickets resolved per month by the support team. The time taken to resolve a ticket depends on the associated complexity. For example, the time taken to resolve a ticket pertaining to the “creation of a new user” in a database may take only a couple of minutes for a first support team. On the contrary, the time taken to resolve a ticket pertaining to a “minor enhancement” in the software may take up to a week by a second support team. Accordingly, the number of tickets pertaining to creation of a new user resolved in a month may be 200, while only 6 tickets pertaining to minor enhancements may be resolved in the same duration. Accordingly, if the number of tickets resolved in a month is the criterion for determining productivity of a support team, the first support team responsible for the creation of a new user would appear to be more productive as compared with the second support team responsible for minor enhancements to the software. This in turn would result in an inaccurate comparative judgment of the productivity of the two support teams. Thus, the number of tickets resolved in a month is not a fair estimate of the productivity of the support team.

In light of the above discussion, there is a need for a method, system, and computer program product for determining the productivity of the support team associated with the maintenance and production support of software that takes into account all the production support requirements, including complexity of a ticket and other factors such as database administration and documentation of the software.

### SUMMARY

The invention provides a method, system, and computer program product for determining productivity of a team associated with the maintenance and production support of software. For determining productivity for a predefined time period, the method enables receiving values corresponding to the number of full time equivalent team-members (FTEs) associated with the production support of the software, the number of tickets associated with the software, and weights corresponding to each of one or more predefined parameters. Each of the tickets is associated with a predefined type. Further, a predefined ticket-unit is associated with each predefined type.

Net ticket-units are determined based on the predefined ticket-unit associated with each of the tickets. Thereafter, an adjustment factor is determined based on the weight corresponding to each of the predefined parameters. Subsequently, adjusted ticket-units are determined based on the net ticket-units and the adjustment factor. The productivity of the team for the predefined time period is then generated based on the adjusted ticket-units and the number of FTEs.

The invention provides a method, system, and computer program product for determining the number of full time equivalent team-members (FTEs) required for maintenance and production support of software. The software may be the software solution that is outsourced by a client company to an IT company for maintenance and production support. For the determination of the number of FTEs, the method enables receiving values corresponding to the number of tickets associated with the software, weights corresponding to each of the predefined parameters associated with the software, and the overall productivity of the organization. Further, each of the tickets is associated with a predefined type, and a predefined ticket-unit is associated with each predefined type. Net ticket-units are determined based on the predefined ticket-unit associated with each of the tickets. Thereafter, an adjustment factor is determined based on the weight corresponding to each of the predefined parameters. Subsequently, adjusted ticket-units corresponding to the software solution are determined based on the net ticket-units and the adjustment factor. The number of FTEs required for a predefined time period is then generated based on the adjusted ticket-units and the overall productivity of the organization.

The method, the system, and the computer program product described above have a number of advantages. The method enables the determination of the productivity of the team associated with the maintenance and production support of software based on a comprehensive list of parameters associated with the software and types of tickets that the team resolves in a predefined time period. Such a determination ensures the determined productivity to be accurate and reliable. Also, such determination of the productivity is an efficient and less error-prone process. Furthermore, the productivity determined may be calculated on a periodic basis, thereby helping the organization to accurately forecast work for a long period of time. The method also enables the determination of the number of FTEs required for maintenance and production support of software based on the adjusted ticket-units associated with the software and the overall productivity of the organization. Such a determination is performed based on the overall productivity of the organization, and hence helps the organization to accurately determine the number of the FTEs for the software.

### BRIEF DESCRIPTION OF THE DRAWINGS

The various embodiments of the invention will hereinafter be described in conjunction with the appended drawings provided to illustrate, and not to limit, the invention, wherein like designations denote like elements, and in which:

FIG. 1 is an environment in which the invention can be practiced, in accordance with various embodiments of the invention;

FIG. 2A and FIG. 2B are tables illustrating types of tickets associated with maintenance and production support of software, in accordance with an embodiment of the invention;

FIG. 3 is a table illustrating the number of full time equivalent team-members associated with maintenance and production support of software, in accordance with the embodiment of the invention;

FIG. 4 is a table illustrating one or more predefined parameters associated with maintenance and production support of software, in accordance with the embodiment of the invention;

FIG. 5A and 5B are flowcharts of a method for determining productivity of a team associated with maintenance and production support of software, in accordance with an embodiment of the invention;

FIG. 6 is flowchart of a method for determining number of full time equivalent team-members required for maintenance and production support of software solution, in accordance with another embodiment of the invention;

FIG. 7 is a block diagram of a productivity determining module for determining productivity of a team associated with maintenance and production support of software, in accordance with an embodiment of the invention; and

FIG. 8 is a block diagram of a team-members determining module for determining number of full time equivalent team-members required for maintenance and production support of software solution, in accordance with another embodiment of the invention.

### DETAILED DESCRIPTION OF THE DRAWINGS

The invention describes a method, system, and computer program product for determining productivity of a team associated with maintenance and production support of software for a predefined time period. Further, the invention provides a method, system, and computer program product for determining the number of full time equivalent team-members, hereinafter referred to as FTEs, required for maintenance and production support of software solution. The software may be a software solution outsourced by a client company to an organization, such as an Information Technology (IT) company, for its maintenance and production.

Terms “determination”, “estimation”, and “generation” have been used interchangeably in association with the productivity of the team within the entire scope of this patent application. Similarly, terms “software application”, “software”, “software solution”, and “application” have also been used interchangeably within the scope of this patent application. Further, it is well known that software may be defined as the combination of one or more computer applications or computer programs for storing data or performing certain tasks.

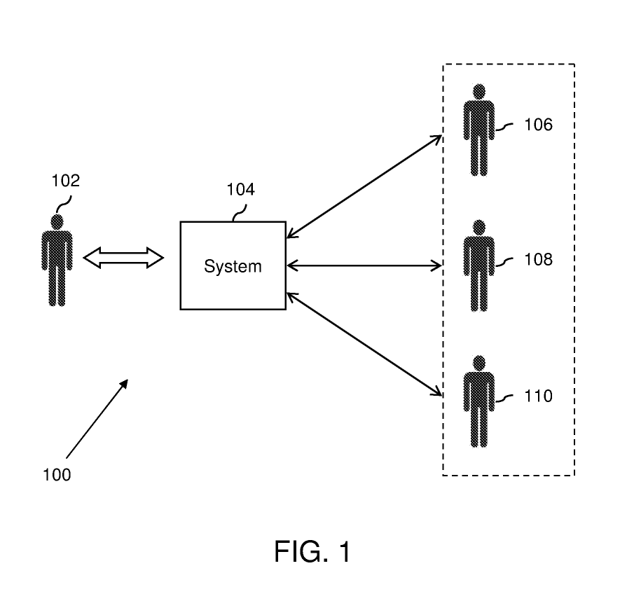

FIG. 1 is an environment 100 in which the invention can be practiced, in accordance with various embodiments of the invention. Exemplary environment 100 includes a user 102 accessing a system 104. User 102 may be an expert in the domain of software maintenance and production support such as a project manager and a team lead. System 104 allows user 102 to manage maintenance and production support of software. Further, user 106, user 108, user 110, and so forth, are depicted as full time equivalent team-members (FTEs) of a team responsible for performing maintenance and production support of the software.

In accordance with an embodiment of the invention, user 102 accesses system 104 to determine productivity of the team associated with maintenance and production support of the software. The productivity of the team may be defined as the efficiency of the team in resolving instances of user-generated requests (tickets) associated with the software in a predefined time period. For example, the team may resolve 500 tickets per month. Further, a ticket may be defined as a user-generated request pertaining to specific tasks that need to be performed for the software. For example, the specific tasks pertaining to software may include the creation of login credentials for new users, deletion of login credentials of specific users, and the like.

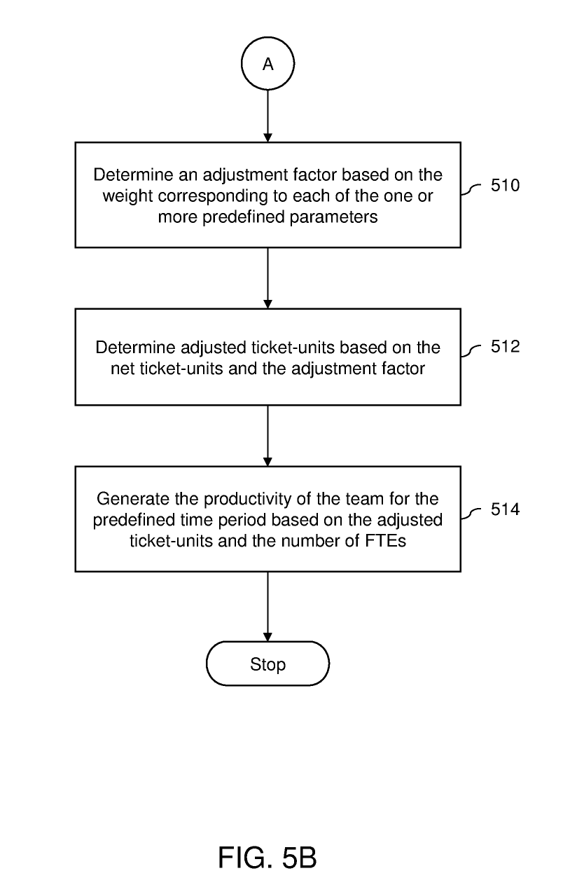

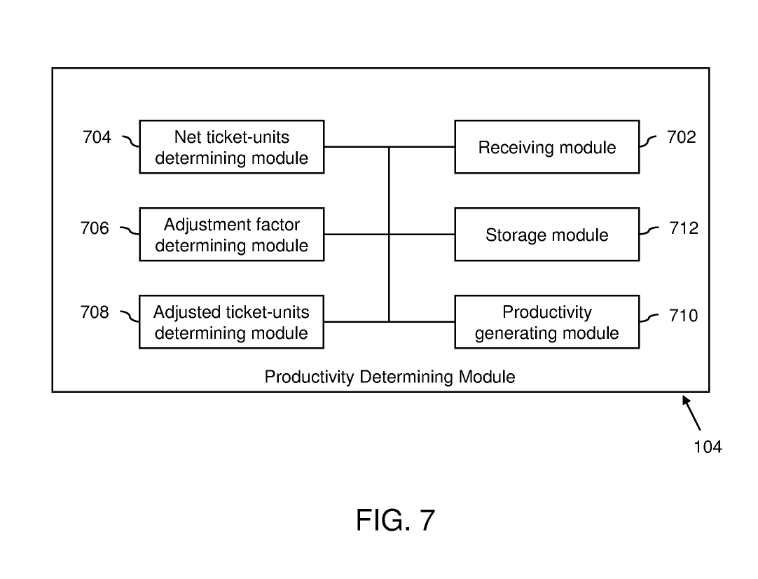

The productivity of the team is determined based on the tickets associated with the software, one or more predefined parameters associated with the software, and the number of FTEs in the team. The one or more predefined parameters are parameters common to all software which influence the maintenance and production support of software. Further, determining the productivity of team is explained in detail in conjunction with FIG. 5 and FIG. 7.

In an exemplary embodiment of the invention, user 102 may be a group manager in a banking institution and he or she may be responsible for managing the productivity of a team associated with the maintenance and production support of banking software. User 102 may access system 104 to determine the productivity of that team in a month and accordingly decide if he or she needs to add more FTEs into the team or to reduce its FTEs for the coming month. The productivity thus determined also helps user 102 to forecast the productivity of the team for the next six months, next one year, and the like.

In accordance with another embodiment of the invention, user 102 accesses system 104 to determine the number of FTEs required for maintenance and production support of a software solution for a predefined time period. The software solution may be software for which an organization such as an IT company needs to provide maintenance and production support. The number of FTEs is determined based on the tickets associated with the software solution, the one or more predefined parameters associated with the software solution, and the overall productivity of the IT company.

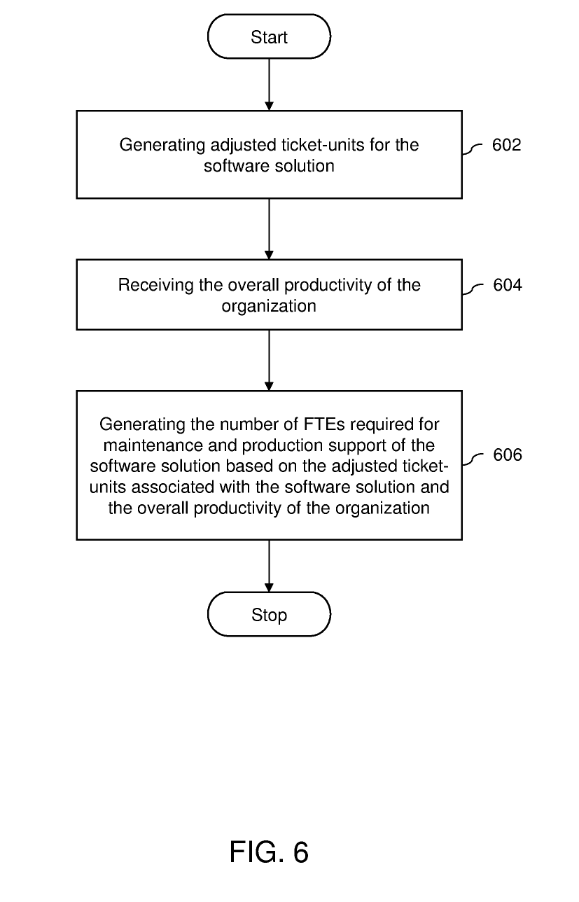

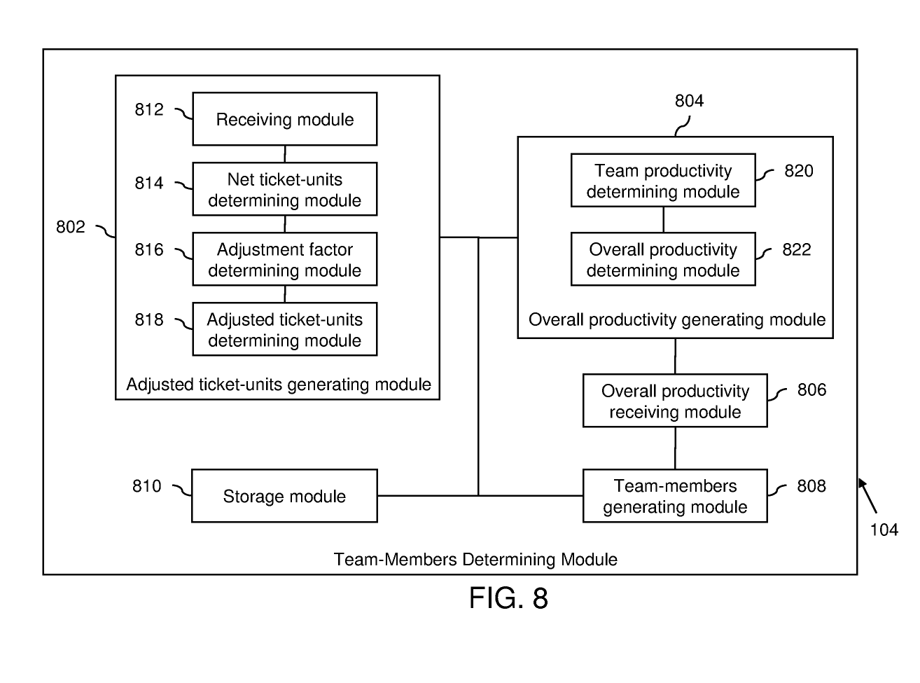

In an exemplary embodiment of the invention, user 102 may be a group manager in a banking institution who is responsible for estimating the number of FTEs required in a team responsible for maintenance and production support of banking software. User 102 may access system 104 to estimate the number of FTEs required to be staffed for the maintenance and production support based on the overall productivity of the banking institution and the past history of the tickets of the banking software. User 102 may also access system 104 to forecast the number of FTEs required for the next six months, next one year, and the like. Further, the estimation of the number of full time equivalent team-members to be staffed is explained in detail in conjunction with FIG. 6 and FIG. 8.

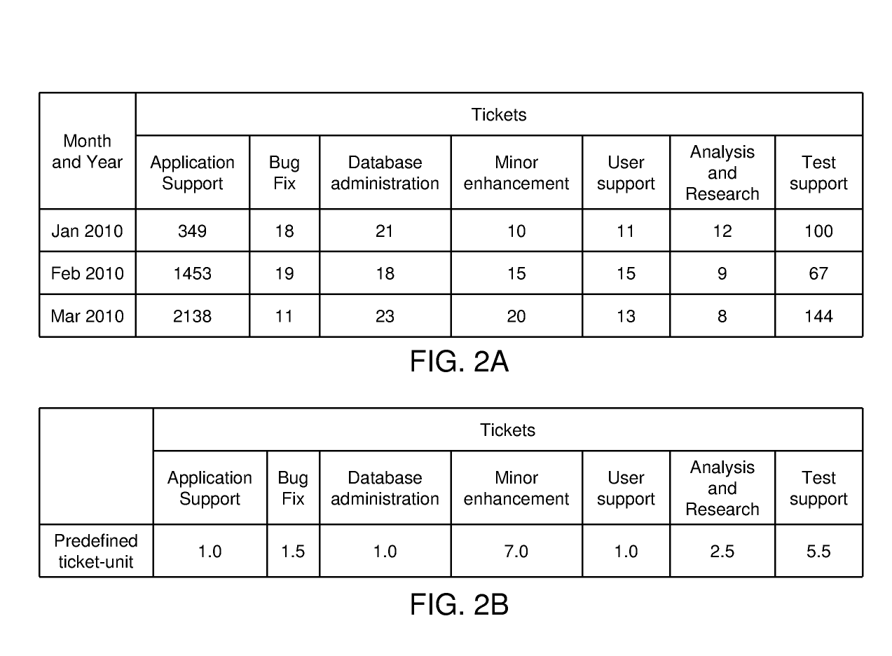

FIG. 2A and FIG. 2B are tables illustrating types of tickets associated with maintenance and production support of software, in accordance with an embodiment of the invention. Further, FIG. 2A also depicts types of tickets along with an exemplary number of tickets corresponding to each of the types of tickets. As described earlier, a ticket represents a user request pertaining to specific tasks that need to be performed for software. For example, a ticket may be a user request for the change of his or her password and for the creation of additional users.

In various embodiments of the invention, the tickets may be further divided into a plurality of types based on the associated function. In an embodiment of the invention, the types of tickets may include, application support, bug fix, database administration, minor enhancement, user support, analysis and research, and test support. It may be apparent to any person skilled in the art that the above mentioned types of tickets are only for illustrative purposes and other types of tickets relating to maintenance and production support of software may be included without deviating from the scope of the invention. Further, these types of tickets are explained in detail below.

In accordance with an embodiment of the invention, the types of tickets are predefined by an expert in the domain of maintenance and production support of software such as a project manager and a team leader. Further, in accordance with an embodiment of the invention, the number of tickets associated with each of the types of tickets is received from a user such as a project manager and a team leader. In accordance with various embodiments of the invention, the number of tickets associated with each of the types of tickets corresponds to a predefined time period such as a week or a month in a calendar year.

For the sake of clarity, the types of tickets are explained in detail below.

Application support—Application support specifies the general support requirements of software including software restart, interface navigation, configuration/setup issues, hardware issues, and networking issues. For example, inventory management software may need to be configured so that it can be concurrently accessed by more than one user or a new version of the inventory management software may need to be installed.

Bug fix—Bug fix is defined as the fixing of an instance of an error stopping or restricting the normal operation of software. For example, a bug affecting banking software may result in the banking software not showing a user's account balance.

Accordingly, the team responsible for maintenance and production support of banking software would be required to fix this bug so that users can check their account balance.

Database administration—Database administration includes a number of activities pertaining to the management of one or more databases associated with the software. These activities include database user management, creation of a new database, modification of an existing database, configuration of database, and the like. For example, database administration would include a weekly backup of the database containing the personal details of all the customers using banking software.

Minor enhancement—A minor enhancement is defined as a minor modification of the software to alter its operation or to incorporate an additional feature in it. For example, a minor modification in the banking software may allow the user to view his/her past payments.

User support—User support includes activities pertaining to software that are aimed to assist a user in accessing the software. These activities may include creation of login credentials for a user, resetting of password corresponding to a user login credentials, and the like. For example, a customer of bank may have forgotten his password and may require the issuance of a new password for accessing the banking software.

Analysis and Research—Analysis and research include activities that are aimed at identifying problems affecting software or identifying solutions for existing problems associated with the software. For example, analysis and research of library management software may uncover a problem due to which the date of return of magazines and publications do not get updated in the library management software.

Test support—Test support includes all the activities pertaining to the testing of software to check if it is executing properly or not. It includes user acceptance testing, system testing, and the like. For example, the activities pertaining to test support may include testing an inventory management system to determine whether it is executing properly before it is delivered to the client and the like.

It may be apparent to a person ordinarily skilled in the art that each of the types of tickets such as application support, bug fix, database administration, minor enhancement, user support, analysis and research, and test support may have numerical value based nomenclature such as “10” or “20”, or similar representations.

FIG. 2A depicts exemplary count for different types of tickets corresponding to the predefined time period—“Jan 2010”, “Feb 2010”, and “Mar 2010”. For “Jan 2010”, the number of tickets for application support is 349, for bug fix is 18, for database administration is 21, for minor enhancement is 10, for user support is 11, for analysis and research is 12, and for test support is 100. Furthermore, the different types of tickets depicted in FIG. 2A are common ticket types for software maintenance and production support.

FIG. 2B depicts the types of tickets with a predefined ticket-unit associated with each types of tickets. The predefined ticket-unit is a comparative unit associated with each type of ticket to represent the complexity associated with resolving a type of ticket vis-à-vis other types of tickets. The predefined ticket-unit may also be referred to as a maintenance unit. In accordance with an embodiment of the invention, the predefined ticket-unit associated with each type of tickets is defined by an expert in the domain of maintenance and production support of software such as a project manager and a team leader.

For example, the predefined ticket-units associated with “minor enhancement” type of ticket may be “7”. This can also be considered to imply that the ticket units associated with each ticket in this type of ticket is 7. Similarly, the predefined ticket-unit associated with “application support” or tickets within this type of tickets may be “1”. This implies that the resolution of a ticket for minor enhancement would be seven times more complex as that required for the ticket for application support. It may be apparent to any person skilled in the art that the predefined ticket-unit associated with each type of ticket is only for illustrative purposes and may vary without deviating from the scope of the invention.

Accordingly, different predefined ticket-units are assigned to different types of tickets to benchmark the predefined tickets on a common platform. Further, a mathematical product of the number of tickets of a type of ticket with its corresponding predefined ticket-unit is determined, which is called as an adjusted ticket-unit. To further elaborate, the adjusted ticket-unit is a unit for comparative measurement of the complexity of resolving different types of tickets. For example, referring to FIG. 2A, the number of tickets in January 2010 for “minor enhancement” is “10” and the number of tickets for “application support” is “349”. In an exemplary embodiment of the invention, the adjusted ticket-unit is determined as: (number of tickets for a type of tickets)×(predefined ticket-unit corresponding to the type of ticket), i.e., 10×7=>70 for minor enhancement and 349×1=>349 for application support. Further, the adjusted ticket unit is explained in detail in conjunction with FIG. 5.

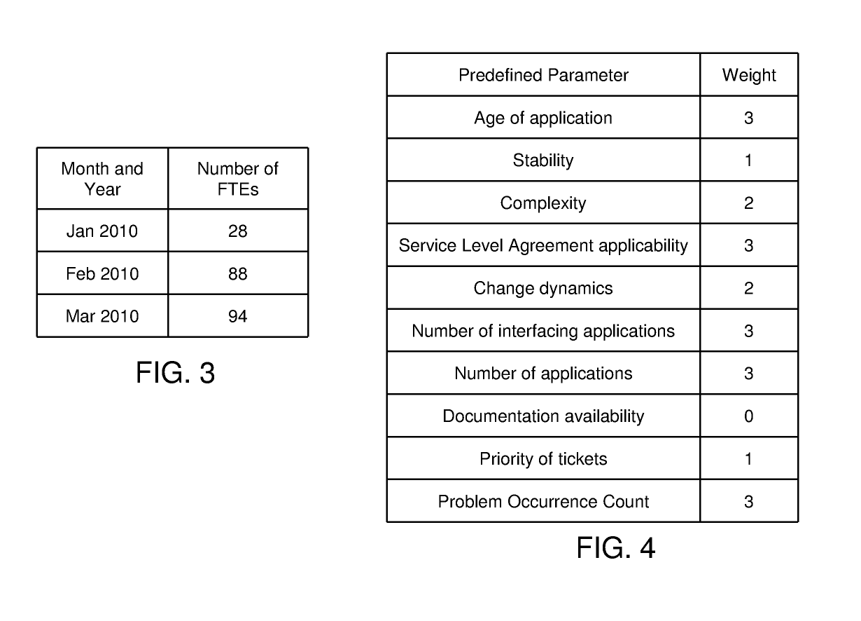

FIG. 3 is a table illustrating the number of full time equivalent team-members associated with maintenance and production support of software, in accordance with the embodiment of the invention. The number of full time equivalent team-members, hereinafter referred to as FTEs, is the count of employees of an organization who are working in a team for managing the maintenance and production support of the software. For example, during January 2010, a team including 28 FTEs manages the maintenance and production support of banking software. Similarly, in February 2010, the number of FTEs managing the maintenance and production-support of the banking software is 88.

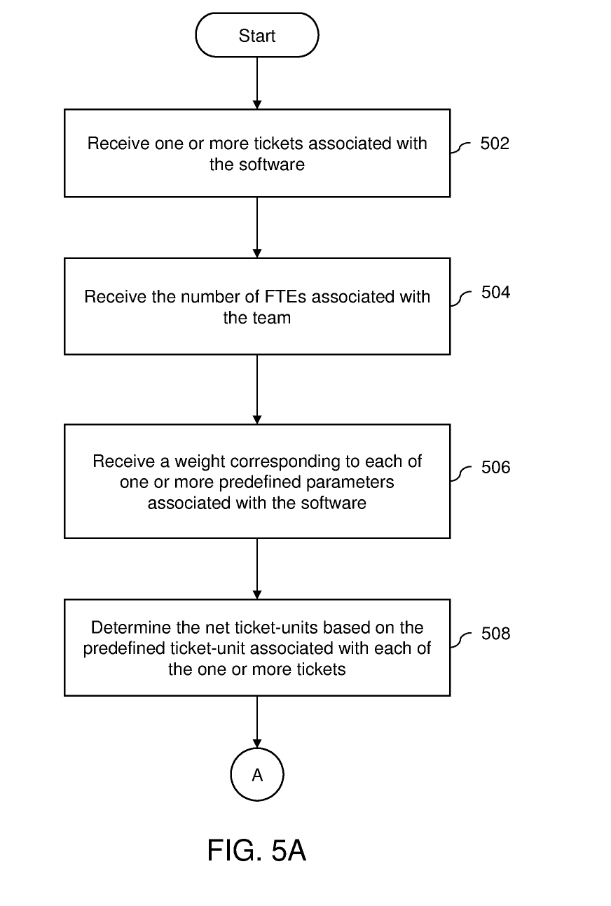

FIG. 4 is a table illustrating one or more predefined parameters associated with maintenance and production support of software, in accordance with the embodiment of the invention. The predefined parameters shown in FIG. 4 are some of the common parameters for different software which influence the maintenance and production support. The predefined parameters include age of application, stability, complexity, service level agreement applicability, change dynamics, number of interfacing applications, number of applications, documentation availability, priority of tickets, and problem occurrence count.

It may be apparent to any person skilled in the art that the above mentioned predefined parameters are only for illustrative purposes and other parameters associated with the software may be included without deviating from the scope of the invention. In accordance with an embodiment of the invention, the predefined parameters are defined by an expert in the domain of maintenance and production support of software such as a project manager and a team leader. Further, in accordance with an embodiment of the invention, weights corresponding to each of the predefined parameters are received from a user such as a project manager for the corresponding software.

Further, for the sake of clarity the predefined parameters are explained in detail below:

Age of application—Age of application is a measure of the number of years since the release of software application. For example, the age of application may be assigned a weight on a scale of “0” to “3”, where “0” represents the age of application less than one year, “1” represents the age of application between one and three years, “2” represents age of application between three to five years while “3” represents age of application more than five years. For example, if Microsoft® Office® 2000 was released in 2000, it will complete ten years in 2010. Accordingly, it will be assigned a weight of “3” as the age of the application as per the given example. However, Microsoft® Office® 2007 was released in 2007 and will accordingly be assigned a weight of “1”.

Stability—Stability of software is a measure of the ability of the software to be executed without any incident stopping or interrupting its execution. Stability may be assigned a weight on a scale of “0” to “3”, where “0” represents high stability, “1” represents medium stability, “2” represent low stability, and “3” may represent an unstable software. For example, banking software may have a higher stability as compared with inventory management software with low stability. Accordingly, the banking software may be assigned a weight of “0”, while the inventory management software may be assigned a weight of “2”.

Complexity—Complexity of software is the level of intricacy involved in the software. Complexity is further divided into two parts: “Functional complexity” and “Technical complexity”. The functional complexity is the measure of the intricacy involved in implementing a business process function in the software. The technical complexity is the measure of technical intricacy involved in building and maintaining the software. Complexity may be assigned a weight on a scale of “0” to “3”, where “0” represents no complexity, “1” represents low complexity, “2” represents medium complexity, and “3” represents high complexity. For example, banking software will typically need to implement a number of complex business process functions such as account management, lending, and capital market investments. Hence, the banking software would have a high level of complexity and may be assigned a weight of “3”. On the contrary, inventory management software would have relatively low complexity and may accordingly be assigned a weight of “1”.

Service Level Agreement applicability—Service Level Agreement (SLA) is a part of the negotiated service contract between a client company and an Information Technology (IT) company. The SLA applicability parameter refers to the type of SLA that is applicable to a software solution. SLA applicability may be assigned a weight on a scale of “0” to “3” where “0” represents no SLA applicability, “1” represents a low SLA applicability, “2” represents a medium SLA applicability, and “3” represents a high SLA applicability. For example, SLA applicability between a bank and an IT company for a banking software solution will typically be high and may accordingly be assigned a weight of “3”. In comparison, SLA applicability between a school and the IT company for a school administration software solution will be low and will accordingly be assigned a weight of “1”.

Change dynamics—Change dynamics refers to the history of enhancements and modifications to software which impact planned enhancements to the software and the frequency of the release of an updated version of the software. The change dynamic parameter may be assigned a weight on a scale of “0” to “3”, where “0” represents no changes, “1” represents low change dynamics, “2” represents moderate change dynamics, and “3” represents high change dynamics. A library management software solution that undergoes only a few enhancements may be assigned a weight of “1”, while banking software with frequent enhancements may be assigned a weight of “3”.

Number of interfacing applications—Number of interfacing applications refers to the count of other software applications interfaced with particular software. The number of interfacing applications parameter may be assigned a weight on a scale of “0” to “3”, where “0” represents up to 2 interfacing applications, “1” represents between 3 to 5 interfacing applications, “2” represents between 6 to 10 interfacing applications, and “3” represents more than 10 interfacing applications. For example, the same banking software may be running in the backend, while four different client software applications are interfacing with it for providing Internet banking access to customers of four different banks. Accordingly, the banking software may be assigned a weight of “1”.

Number of applications—Number of applications refers to the count of individual software applications in a software solution that requires maintenance and production support. The number of applications parameter may be assigned a weight on a scale of “0” to “3”, where “0” represents up to 2 applications, “1” represents between 3 to 5 applications, “2” represents between 6 to 10 applications, and “3” represents more than 10 interfacing applications. For example, Microsoft® Office® software may include Microsoft® Office Word®, Microsoft® Outlook®, Microsoft® PowerPoint®, Microsoft® Tools®, and Microsoft® Excel®. Accordingly, it will be assigned a weight of “1”.

Documentation availability—Documentation availability refers to the level of availability of critical and supporting documents pertaining to software. The documentation availability parameter may be assigned a weight on a scale of “0” to “3”, where “0” represents the availability of all critical and supporting documents, “1” represents the availability of all critical documents only, “2” represents the availability of only a few critical documents, and “3” represents the availability of no critical or supporting documents. For example, if all necessary critical and support documentation for library management software is available, it will be assigned a weight of “0”.

Priority of tickets—Tickets or user requests may generally be of three primary priorities: low, medium, and high. A high priority ticket may require immediate attention of the team providing maintenance and production support of software, while low and medium priority tickets may not require immediate attention of the team. Accordingly, the priority of tickets parameter is assigned a weight based on the priority of most of the tickets associated with the software. The priority of tickets may be assigned a weight on a scale of “0” to “3”, where “0” represents tickets with mostly low priority, “1” represents tickets with mostly medium priority, “2” represents tickets with a combination of low, medium, and high priorities, and “3” represents tickets with mostly high priority. For example, if most of the tickets associated with banking software are of low priority, the priority of tickets parameter may be assigned a weight of “0”, whereas if most of the tickets associated with the banking software are high priority, the priority of tickets parameter may be assigned a weight of “3”.

Problem occurrence count—Problem occurrence count is the count of tickets or user-generated requests pertaining to software raised in a predefined time period such as a month and a year. The problem occurrence count parameter may be assigned a weight on a scale of “0” to “3”, where “0” represents a problem occurrence count of less than fifteen user-generated requests, “1” represents a problem occurrence count between 16 and 30, “2” represents a problem occurrence count between 31 and 100 user-generated requests, and “3” represents a problem occurrence count of more than 100 user-generated requests. For example, banking software may have over 100 tickets or user-generated requests associated with it, while library management software may have only 13 tickets or user requests associated with it in the same time period. Accordingly, the banking software will be assigned a weight of “3”, while the library management software will be assigned a weight of “0”.

It may be apparent to any person ordinarily skilled in the art that each of the predefined parameters may also be assigned weight on a scale of “1” to “5”, “1” to “10”, or other similar representations. It may also be apparent to any person skilled in the art that the definition of each weight for a predefined parameter is only for illustrative purposes and may vary from one software solution to another software solution. For example, the definition of weight corresponding to problem occurrence count for a software solution deployed in a 200-user organization will mostly vary from those for the same software solution deployed in an organization with 10,000 users.

FIG. 5A and 5B are flowcharts of a method for determining productivity of a team associated with maintenance and production support of software, in accordance with an embodiment of the invention.

At 502, one or more tickets associated with the software are received. The one or more tickets associated with the software have been explained in detail in conjunction with FIG. 2A and FIG. 2B. Additionally, the one or more tickets are divided into a plurality of types based on the function associated with each type.

For example, the number of tickets for “application support, bug fix, database administration, minor enhancement, user support, analysis and research, and test support types of tickets” for the predefined time period “Jan 2010” may be “349, 18, 21, 10, 11, 12 and 100”, respectively.

At 504, the number of FTEs associated with the team is received. For example, the number of FTEs associated with the team for the predefined time period “Jan 2010” may be “28”.

At 506, a weight corresponding to each of one or more predefined parameters associated with the software is received. The predefined parameters associated with the software are explained in detail in conjunction with FIG. 4.

For example, the weight corresponding to predefined parameters: age of application, stability, complexity, service level agreement applicability, change dynamics, number of interfacing applications, number of applications, documentation availability, priority of tickets, and problem occurrence count may be 3, 1, 2, 3, 2, 3, 3, 0, 1, and 3, respectively.

At 508, the net ticket-units is determined based on the predefined ticket-unit associated with each of the one or more tickets.

In an exemplary embodiment of the invention, the net ticket-units may be determined as: ΣXᵢYᵢ where i represents type of tickets (varies from 1 to the total number of type of tickets), X represents the number of tickets for each type of tickets, and Y represents the predefined ticket-unit associated each type of tickets. In continuation to the above example, the net-ticket units for the types of tickets, number of tickets per type of tickets, and the predefined ticket-units as shown in FIGS. 2A and 2B will be as follows:

((349×1.0)+(18×1.5)+(21×1.0)+(10×7.0)+(11×1.0)+(12×2.5)+(100×5.5))=>349+27+21+70+11+30+550=>1058 net ticket-units.

At 510, an adjustment factor is determined based on the weight corresponding to each of the one or more predefined parameters.

In an exemplary embodiment of the invention, the adjustment factor may be determined as 0.8+(sum of weight corresponding to each predefined parameter x 0.013). Accordingly, the adjustment factor for pre-defined parameters and the corresponding weight shown in FIG. 4 is 0.8+((3+1+2+3+2+3+3+0+1+3)×0.013)=>0.8+(21×0.013)=>0.8+0.273=>1.073. It may be apparent to any person skilled in the art that above mentioned formula for calculating the adjustment factor is for the exemplary purposes. Other formulae may also be used without deviating from the scope of the invention.

At 512, adjusted ticket-units is determined based on the net ticket-units and the adjustment factor.

In an exemplary embodiment of the invention, the adjusted ticket-units are determined as net ticket-units x adjustment factor. Accordingly, the adjusted ticket-units corresponding to net-ticket units and adjustment factor determined at 508 and 510 is 1058×1.073=>1135.23 adjusted ticket-units.

At 514, the productivity of the team for the predefined time period is generated based on the adjusted ticket-units and the number of FTEs.

In an exemplary embodiment of the invention, the productivity of the team for the predefined time period is determined as the adjusted ticket-units/the number of FTEs for the predefined time period. Continuing with the example, the productivity is 1135.23/28=>40.54. Thus, a productivity of 40.54 implies that the team working on maintenance and production support of the software can resolve 40.54 adjusted ticket-units in a predefined time period. It may be apparent to any person skilled in the art that the productivity is determined as ticket-units resolved per team for a predefined time period.

In various embodiments of the invention, the productivity of the team can be shown to a user of a computer system with the help of a generic Graphical User Interface (not shown in the figure). Further, the number of tickets, the predefined ticket-unit associated each of the types of tickets, the number of FTEs, and the weight corresponding to each of the predefined parameters may be received as input by a user or may be received from a repository. Examples of repository include, but are not limited to, a database table, an MS Access® file, and an MS Word® file. In various embodiments of the invention, the number of tickets, the number of FTEs, and the weight corresponding to each of the predefined parameters may be received as an input by the user of a computer system with the help of a generic Graphical User Interface (not shown in the figure).

In accordance with an embodiment of the invention, the productivity of the team, the number of tickets, the predefined ticket-unit associated with each of the types of tickets, the number of FTEs, and the weight corresponding to each of the predefined parameters may be stored in a local storage or a remote repository. Examples of repository include, but are not limited to, a database table, and an MS Access® file.

It may be apparent to a person ordinarily skilled in the art that the mathematical relationship between the types of tickets, the ticket-units associated with the types of tickets, the number of FTEs, and the weight corresponding to each of the predefined parameters for determining productivity of the team is for illustrative purposes only and may vary without deviating from the scope of the invention.

FIG. 6 is flowchart of a method for determining number of full time equivalent team-members required for maintenance and production support of software solution, in accordance with another embodiment of the invention. The software solution may be software for which an organization, such as an IT company, may need to provide maintenance and production support. Accordingly, the IT company needs to determine the number of full time equivalent team-members, hereinafter referred to as FTEs, that may be required for maintenance and production support of the software solution.

At 602, adjusted ticket-units are generated for the software solution. The adjusted ticket-units for the software solution are generated as explained in detail in conjunction with FIG. 5A and FIG. 5B (from 502 to 512). For example, the adjusted ticket-units for the software solution may be determined to be “288”.

At 604, the overall productivity of the organization is received. The overall productivity of an organization is defined as the efficiency of the organization in resolving instances of user-generated requests (tickets) associated with one or more software in a predefined time period, the one or more software being managed by corresponding one or more teams of the organization. The method for determination of productivity of the team associated with maintenance and production support of software has been explained in detail in conjunction with FIG. 5A and FIG. 5B. The IT company may include one or more teams working separately or in combinations to perform maintenance and production support of one or more software. Thus, the overall productivity of the IT company may be determined based on the productivity of one or more teams of the IT company. In an embodiment of the invention, the overall productivity of the IT company may be determined based on the statistical analysis of the productivity of each team in the IT company. For example, the productivity of a first team of the IT company may be “17.09”, while the productivity of a second team of the IT company may be “19.34”. Thus, the overall productivity of the IT company may be determined as the average of the productivities of the first team and the second team, i.e., (17.09+19.34)/2=>18.22. It may be apparent to any person skilled in the art that the productivity is determined as ticket-units resolved per team for a predefined time period.

At 606, the number of FTEs required for maintenance and production support of the software solution is generated based on the adjusted ticket-units associated with the software solution and the overall productivity of the organization.

In an exemplary embodiment of the invention, the number of FTEs required for maintenance and production support of the software solution may be determined as adjusted ticket-units associated with the software solution divided by the overall productivity of the IT company. Continuing with the example in step 604, the productivity will be 288/18.22=>15.8, which when rounded off to the next whole number gives 16. Thus, the number of FTEs required for maintenance and production support of the software solution is “16”.

The adjusted ticket units and the overall productivity of the IT company may be received as input by a user or from a repository or may also be determined as explained in detail in conjunction with FIGS. 5A, 5B, and 6. Examples of repository include, but are not limited to, a database table, an MS Access® file, and an MS Word® file. In various embodiments of the invention, the adjusted ticket-units and the overall productivity of the organization may be received as an input by the user of a computer system with the help of a generic Graphical User Interface (not shown in the figure) as may be apparent to a person ordinarily skilled in the art.

In accordance with an embodiment of the invention, the adjusted ticket-units associated with the software solution, the overall productivity of the IT company, and the number of FTEs required for maintenance and production support of the software solution may be stored in a local storage or a remote repository. Examples of local storage include, but are not limited to, the internal hard-drive or solid state drive of a computer system. Examples of repository include, but are not limited to, a database table and an MS Access® file.

It may be apparent to a person ordinarily skilled in the art that the mathematical relationship between the adjusted ticket-units and the overall productivity of the IT company is for illustrative purposes only and may vary without deviating from the scope of the invention.

FIG. 7 is a block diagram of a productivity determining module 104 for determining productivity of a team associated with maintenance and production support of software, in accordance with an embodiment of the invention. Productivity determining module 104 includes a receiving module 702, a net ticket-units determining module 704, an adjustment factor determining module 706, an adjusted ticket units determining module 708, a productivity generating module 710, and a storage module 712.

In various embodiments of the invention, productivity determining module 104 determines productivity of the team associated with maintenance and production support of the software for a predefined time period. As explained earlier, productivity of the team is determined based on the types of tickets, number of full time equivalent team-members (FTEs) associated with the team and one or more predefined parameters. Some examples of the types of tickets are application support, bug fix, database administration, minor enhancement, user support, analysis and research, and test support. Further, the predefined parameters may include, but are not limited to, age of application, stability, complexity, SLA applicability, change dynamics, number of interfacing applications, number of applications, documentation availability, priority of tickets, and problem occurrence count.

In an embodiment of the invention, receiving module 702 receives one or more tickets corresponding to each of the types of tickets associated with the software for the predefined time period, number of FTEs associated with the team and weight corresponding to each of one or more predefined parameters. The types of tickets, the number of FTEs, and the weight corresponding to each of the predefined parameters have been explained in detail in conjunction with FIGS. 2A, 2B, 3, and 4 respectively. Net ticket-units determining module 704 then determines net ticket-units based on the predefined ticket-unit associated with each of the types of tickets. Thereafter, adjustment factor determining module 706 determines an adjustment factor based on the weight corresponding to each of the one or more predefined parameters. Subsequently, adjusted ticket-units determining module 708 determines adjusted ticket-units based on the net ticket-units and the adjustment factor.

Productivity generating module 710 then generates productivity of the team associated with maintenance and production support of the software for the predefined time period based on the adjusted ticket-units and the number of FTEs. It may be apparent to a person ordinarily skilled in the art that other mathematical operations may be applied to the net ticket-units and the adjustment factor to obtain the productivity of the team. In accordance with an embodiment of the invention, the method for determining productivity of a team associated with maintenance and production support of software has been explained in detail in conjunction with FIGS. 5A and 5B.

Thereafter, the productivity of the team is stored in storage module 712. In an embodiment of the invention, the productivity of the team can also be shown to a user of a computer system with the help of a generic Graphical User Interface (not shown in the figure) as may be apparent to a person ordinarily skilled in the art.

In another embodiment of the invention, storage module 712 stores the number of FTEs, the one or more tickets, the predefined ticket-unit associated with each of the one or more tickets, the one or more predefined parameters, the weight corresponding to each of the one or more predefined parameters, and the productivity of the team.

In various embodiments of the invention, receiving module 702, net ticket-units determining module 704, adjustment factor determining module 706, adjusted ticket-units determining module 708, productivity generating module 710, and storage module 712 of productivity determining module 104 can be implemented in the form of hardware, software, firmware, and/or combinations, thereof.

In various embodiments of the invention, productivity determining module 104 utilizes the computational capabilities of a microprocessor of a computational device (not shown in the figure).

FIG. 8 is a block diagram of a team-members determining module 104 for determining number of full time equivalent team-members required for maintenance and production support of a software solution, in accordance with another embodiment of the invention. The software solution may be software for which an organization, such as an IT company, may need to provide maintenance and production support. Accordingly, the IT company needs to determine the number of full time equivalent team-members (FTEs) that may be required for maintenance and production support of the software solution.

Team-members determining module 104 includes an adjusted ticket-units generating module 802, an overall productivity generating module 804, an overall productivity receiving module 806, a team-members generating module 808, and a storage module 810. Adjusted ticket-units generating module 802 further includes a receiving module 812, a net ticket-units determining module 814, an adjustment factor determining module 816, and an adjusted ticket-units determining module 818. Overall productivity generating module 804 further includes a team productivity determining module 820, and an overall productivity determining module 822.

In various embodiments of the invention, team-members determining module 104 determines the number of FTEs required for maintenance and production support of the software solution. As explained earlier in FIG. 6, the number of FTEs is determined based on the types of tickets, the overall productivity of the IT company, and the one or more predefined parameters. Further, the types of tickets and the predefined parameters have been explained in detail in conjunction with FIGS. 2 to 7.

In an embodiment of the invention, adjusted ticket-units generating module 802 generates adjusted ticket-units associated with the software solution. For this purpose, receiving module 812 receives one or more tickets associated with the software solution and weight corresponding to each of one or more predefined parameters. Net ticket-units determining module 814 then determines net ticket-units based on the predefined ticket-unit associated with each of the one or more tickets. Thereafter, adjustment factor determining module 816 determines an adjustment factor based on the weight corresponding to each of the one or more predefined parameters. Subsequently, adjusted ticket-units determining module 818 determines adjusted ticket-units for the software solution based on the net ticket-units and the adjustment factor. Further, the method of generation of the adjusted ticket units is explained in detail in conjunction with FIG. 5 (502-512).

In accordance with an embodiment of the invention, overall productivity generating module 804 generates overall productivity of IT company based on the productivity of each team of one or more teams associated with maintenance and production support of each software of one or more software managed by the IT company. For this purpose, team productivity determining module 820 of overall productivity generating module 804 interacts with adjusted ticket-units generating module 802 to determine productivity of each team of the one or more teams for the predefined time period based on the adjusted ticket-units for each software and the number of FTEs in each team. It may be apparent to any person skilled in the art that the IT company may include one or more teams working separately or in combinations to perform maintenance and production support of the one or more software. Thereafter, overall productivity determining module 822 determines overall productivity of the IT company based on the statistical analysis of the productivity of each team of the one or more teams. The method for determination of productivity of the team associated with maintenance and production support of software has been explained in detail in conjunction with FIGS. 5A and 5B. Thus, overall productivity generating module 804 generates the overall productivity of the IT company.

In accordance with another embodiment of the invention, overall productivity receiving module 806 directly receives the overall productivity of the IT company as an input from a user or from a repository. The user may be an employee of the IT company such as a project manager and a team leader. It may be apparent to any person skilled in the art that the received overall productivity of the IT company is based on ticket-units resolved by one or more teams in the IT company for a predefined time period.

Subsequently, team-members generating module 808 generates the number of FTEs required for maintenance and production support of the software solution. It is based on the adjusted ticket-units for the software solution and the overall productivity of the IT company. In accordance with an embodiment of the invention, the method for determining number of FTEs required for maintenance and production support of the software solution has been explained in detail in conjunction with FIG. 6.

Thereafter, the number of FTEs is stored in storage module 810. In an embodiment of the invention, the number of FTEs can also be shown to a user of a computer system with the help of a generic Graphical User Interface (not shown in the figure) as may be apparent to a person ordinarily skilled in the art.

In another embodiment of the invention, storage module 712 stores the number of FTEs of the organization, the one or more tickets, the predefined ticket-unit associated with each of the one or more tickets, the one or more predefined parameters, the weight corresponding to each of the one or more predefined parameters, the number of FTEs associated with the one or more teams, the overall productivity of the organization, and the productivity of each team.

In various embodiments of the invention, adjusted ticket-units generating module 802, overall productivity generating module 804, overall productivity receiving module 806, team-members generating module 808, storage module 810, receiving module 812, net ticket-units determining module 814, adjustment factor determining module 816, adjusted ticket-units determining module 818, team productivity determining module 820, and overall productivity determining module 822 of team-members determining module 104 can be implemented in the form of hardware, software, firmware, and/or combinations thereof.

In various embodiments of the invention, team-members determining module 104 utilizes the computational capabilities of a microprocessor of a computational device (not shown in the figure).

The method, the system, and the computer program product described above have a number of advantages. The method enables the determination of the productivity of the team associated with the maintenance and production support of software based on a comprehensive list of parameters associated with the software and types of tickets that the team resolves in a predefined time period. Such a determination ensures the determined productivity to be accurate and reliable. Also, such determination of the productivity is an efficient and less error-prone process. Furthermore, the productivity determined may be calculated on a periodic basis, thereby helping the organization to accurately forecast work for a long period of time. The method also enables the determination of the number of full time equivalent team-members (FTEs) required for maintenance and production support of software based on the adjusted ticket-units associated with the software and the overall productivity of the organization. Such a determination is performed based on the overall productivity of the organization, and hence helps the organization to accurately determine the number of the FTEs for the software.

The method and system for determining productivity of a team for maintenance and production support of software, as described in the present invention, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method for the present invention.

The computer system typically comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can be a hard disk drive or a removable storage drive such as a floppy disk drive and an optical disk drive. The storage device can be other similar means for loading computer programs or other instructions into the computer system.

The computer system executes a set of instructions that are stored in one or more storage elements to process input data. These storage elements can also hold data or other information, as desired, and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at or prior to the time of use. Examples of such external computer program products are computer-readable storage mediums such as CD-ROMS, Flash chips, and floppy disks.

The set of instructions may include various commands that instruct the processing machine to perform specific tasks such as the steps that constitute the method for the present invention. The set of instructions may be in the form of a software program or a computer readable program code embodying the method in a computer usable medium. The software may be in various forms such as system software or application software. Further, the software may be in the form of a collection of separate programs, a program module with a large program, or a portion of a program module. The software may also include modular programming in the form of object-oriented programming. The software program that contains the set of instructions can be embedded in a computer program product for use with a computer, the computer program product comprising a computer-usable medium with a computer-readable program code embodied therein. The processing of input data by the processing machine may be in response to users' commands, results of previous processing, or a request made by another processing machine.

The modules described herein may include processors and program instructions that are used to implement the functions of the modules described herein. Some or all the functions can be implemented by a state machine that has no stored program instructions, or in one or more Application-Specific Integrated Circuits (ASICs), in which each function or some combinations of some of the functions are implemented as custom logic.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

What is claimed is:

1. A method for determining productivity of a team associated with maintenance and production support of software, the productivity of the team being determined for a predefined time period, the method comprising:
a. receiving one or more tickets associated with the software, wherein a ticket is a user generated request, the one or more tickets being received corresponding to the predefined time period, each ticket of the one or more tickets being associated with a predefined type, wherein a predefined ticket-unit is associated with each predefined type;
b. receiving the number of full time equivalent team-members (FTEs) associated with the team;
c. receiving a weight corresponding to each of one or more predefined parameters associated with the software;
d. determining net ticket-units based on the predefined ticket-unit associated with each of the one or more tickets;
e. determining an adjustment factor based on the weight associated with each of the one or more predefined parameters;
f. determining adjusted ticket-units based on the net ticket-units and the adjustment factor; and
g. generating the productivity of the team for the predefined time period based on the adjusted ticket-units and the number of FTEs.

2. The method according to claim 1 further comprising storing at least one of the number of FTEs, the one or more tickets, the predefined ticket-unit associated with each of the one or more tickets, the one or more predefined parameters, the weight corresponding to each of the one or more predefined parameters, and the productivity of the team.

3. The method according to claim 1, wherein the one or more tickets include at least one of an application support, a bug fix, a database administration, a minor enhancement, a user support, an analysis and research, and a test support.

4. The method according to claim 1, wherein the one or more predefined parameters include at least one of an age of application, a stability, a complexity, a service level agreement applicability, a change dynamics, a number of interfacing applications, a number of applications, a documentation availability, a priority of tickets, and a problem occurrence count.

5. The method according to claim 1, wherein the number of FTEs associated with the team, the one or more tickets, the predefined type associated with each of the one or more tickets, and the weight associated with each of the one or more predefined parameters are received at least from a user and a repository.

6. A method for determining number of full time equivalent team-members (FTEs) of an organization required for maintenance and production support of a software solution, the method comprising:
a. generating adjusted ticket-units for the software solution, the generation of the adjusted ticket-units comprising:
i. receiving one or more tickets associated with the software solution, wherein a ticket is a user generated request, the one or more tickets being received corresponding to a predefined time period, each ticket of the one or more tickets being associated with a predefined type, wherein a predefined ticket-unit is associated with each predefined type;
ii. receiving a weight corresponding to each of one or more predefined parameters associated with the software solution;
iii. determining net ticket-units based on the predefined ticket-unit associated with each of the one or more tickets with the software solution;
iv. determining an adjustment factor based on the weight corresponding to each of the one or more predefined parameters associated with the software solution; and
v. determining adjusted ticket-units for the software solution based on the net ticket-units and the adjustment factor;
b. receiving the overall productivity of the organization, the overall productivity of the organization being based on productivity of one or more teams of the organization; and
c. generating the number of FTEs required for maintenance and production support of the software solution based on the adjusted ticket-units associated with the software solution and the overall productivity of the organization.

7. The method according to claim 6 further comprising generating the overall productivity of the organization, the organization comprising one or more teams associated with maintenance and production support of one or more software, the generation of the overall productivity of the organization comprising:
a. receiving one or more tickets associated with the one or more software, wherein a ticket is a user generated request, the one or more tickets being received corresponding to a predefined time period, each ticket of the one or more tickets being associated with a predefined type, wherein a predefined ticket-unit is associated with each predefined type;
b. receiving the number of FTEs associated with the one or more teams;
c. receiving a weight corresponding to each of the one or more predefined parameters associated with the one or more software;
d. determining net ticket-units based on the predefined ticket-unit associated with each of the one or more tickets associated with the one or more software;
e. determining an adjustment factor based on the weight corresponding each of the one or more predefined parameters associated with the one or more software;
f. determining adjusted ticket-units for the one or more software based on the net ticket-units and the adjustment factor;
g. determining productivity of each team of the one or more teams for the predefined time period based on the adjusted ticket-units and the number of FTEs associated with each team; and
h. generating the overall productivity of the organization based on a statistical analysis of the productivity of each team.

8. The method according to claim 7 further comprising storing at least one of the number of FTEs of the organization, the one or more tickets, the predefined ticket-unit associated with each of the one or more tickets, the one or more predefined parameters, the weight corresponding to each of the one or more predefined parameters, the number of FTEs associated with the one or more teams, the overall productivity of the organization, and the productivity of each team.

9. A productivity determining module for determining productivity of a team associated with maintenance and production support of software, the productivity of the team being determined for a predefined time period, the productivity determining module comprising:
a. a receiving module configured for:
i. receiving one or more tickets associated with the software, wherein a ticket is a user generated request, the one or more tickets being received corresponding to the predefined time period, each ticket of the one or more tickets being associated with a predefined type, wherein a predefined ticket-unit is associated with each predefined type;
ii. receiving the number of full time equivalent team-members (FTEs) associated with the team;
iii. receiving a weight corresponding to each of one or more predefined parameters associated with the software;
b. a net ticket-units determining module configured for determining net ticket-units based on the predefined ticket-unit associated with each of the one or more tickets;
c. an adjustment factor determining module configured for determining an adjustment factor based on the weight associated with each of the one or more predefined parameters;
d. an adjusted ticket-units determining module configured for determining adjusted ticket-units based on the net ticket-units and the adjustment factor; and
e. a productivity generating module configured for generating the productivity of the team for the predefined time period based on the adjusted ticket-units and the number of FTEs.

10. The productivity determining module according to claim 9 further comprising a storage module configured for storing at least one of the number of FTEs, the one or more tickets, the predefined ticket-unit associated with each of the one or more tickets, the one or more predefined parameters, the weight corresponding to each of the one or more predefined parameters, and the productivity of the team.

11. A team-members determining module for determining number of full time equivalent team-members (FTEs) of an organization required for maintenance and production support of a software solution, the team-members determining module comprising:
a. an adjusted ticket-units generating module for generating adjusted ticket-units for the software solution, the adjusted ticket-units generating module further comprising:
i. a receiving module configured for:
1. receiving one or more tickets associated with the software solution, wherein a ticket is a user generated request, the one or more tickets being received corresponding to a predefined time period, each ticket of the one or more tickets being associated with a predefined type, wherein a predefined ticket-unit is associated with each predefined type;
2. receiving a weight corresponding to each of one or more predefined parameters associated with the software solution;
ii. a net ticket-units determining module configured for determining net ticket-units based on the predefined ticket-unit associated with each of the one or more tickets with the software solution;
iii. an adjustment factor determining module configured for determining an adjustment factor based on the weight corresponding to each of the one or more predefined parameters associated with the software solution; and
iv. an adjusted ticket-units determining module configured for determining adjusted ticket-units for the software solution based on the net ticket-units and the adjustment factor;
b. an overall productivity receiving module configured for receiving the overall productivity of the organization, the overall productivity of the organization being based on productivity of one or more teams of the organization; and
c. a team-members generating module configured for generating the number of FTEs required for maintenance and production support of the software solution based on the adjusted ticket-units associated with the software solution and the overall productivity of the organization.

12. The team-members determining module according to claim 11, wherein the adjusted ticket-units generating module is further configured for generating adjusted ticket-units for one or more software associated with the organization, the organization comprising one or more teams associated with maintenance and production support of the one or more software.

13. The team-members determining module according to claim 12, wherein the receiving module is further configured for receiving the number of FTEs associated with the one or more teams.

14. The team-members determining module according to claim 13 further comprising an overall productivity generating module configured for generating the overall productivity of the organization, the overall productivity generating module comprising:
a. a team productivity determining module configured for determining productivity of each team of the one or more teams for the predefined time period based on the adjusted ticket-units for each software of the one or more software and the number of FTEs associated with each team; and
b. an overall productivity determining module configured for determining the overall productivity of the organization based on the statistical analysis of the productivity of each team.

15. The team-members determining module according to claim 14 further comprising a storage module configured for storing at least one of the number of FTEs of the organization, the one or more tickets, the predefined ticket-unit associated with each of the one or more tickets, the one or more predefined parameters, the weight corresponding to each of the one or more predefined parameters, the number of FTEs associated with the one or more teams, the overall productivity of the organization, and the productivity of each team.

16. A computer program product for use with a computer, the computer program product comprising a computer usable medium having a computer readable program code embodied therein for determining productivity of a team associated with maintenance and production support of software, the productivity of the team being determined for a predefined time period, the computer readable program code performing:
a. receiving one or more tickets associated with the software, wherein a ticket is a user generated request, the one or more tickets being received corresponding to the predefined time period, each ticket of the one or more tickets being associated with a predefined type, wherein a predefined ticket-unit is associated with each predefined type;
b. receiving the number of full time equivalent team-members (FTEs) associated with the team;
c. receiving a weight corresponding to each of one or more predefined parameters associated with the software;
d. determining net ticket-units based on the predefined ticket-unit associated with each of the one or more tickets;
e. determining an adjustment factor based on the weight associated with each of the one or more predefined parameters;
f. determining adjusted tickets-units based on the net ticket-units and the adjustment factor; and
g. generating the productivity of the team for the predefined time period based on the adjusted ticket-units and the number of FTEs.

17. The computer program product according to claim 14, wherein the computer readable program code further performs storing at least one of the number of FTEs, the one or more tickets, the predefined ticket-unit associated with each of the one or more tickets, the one or more predefined parameters, the weight corresponding to each of the one or more predefined parameters, and the productivity of the team.

18. A computer program product for use with a computer, the computer program product comprising a computer usable medium having a computer readable program code embodied therein for determining number of full time equivalent team-members (FTEs) of an organization required for maintenance and production support of a software solution, the computer readable program code performing:
a. generating adjusted ticket-units for the software solution, the generation of the adjusted ticket-units comprising:
i. receiving one or more tickets associated with the software solution, wherein a ticket is a user generated request, the one or more tickets being received corresponding to a predefined time period, each ticket of the one or more tickets being associated with a predefined type, wherein a predefined ticket-unit is associated with each predefined type;
ii. receiving a weight corresponding to each of one or more predefined parameters associated with the software solution;
iii. determining net ticket-units based on the predefined ticket-unit associated with each of the one or more tickets with the software solution;
iv. determining an adjustment factor based on the weight corresponding to each of the one or more predefined parameters associated with the software solution; and
v. determining adjusted ticket-units for the software solution based on the net ticket-units and the adjustment factor;
b. receiving the overall productivity of the organization, the overall productivity of the organization being based on productivity of one or more teams of the organization; and
c. generating the number of FTEs required for maintenance and production support of the software solution based on the adjusted ticket-units associated with the software solution and the overall productivity of the organization.

19. The computer program product according to claim 18, wherein the computer readable program code further performs generating the overall productivity of the organization, the organization comprising one or more teams associated with maintenance and production support of one or more software, the generation of the overall productivity of the organization comprising:
a. receiving one or more tickets associated with the one or more software, wherein a ticket is a user generated request, the one or more tickets being received corresponding to a predefined time period, each ticket of the one or more tickets being associated with a predefined type, wherein a predefined ticket-unit is associated with each predefined type;
b. receiving the number of full time equivalent team-members (FTEs) associated with the one or more teams;
c. receiving a weight corresponding to each of the one or more predefined parameters associated with the one or more software;
d. determining net ticket-units based on the predefined ticket-unit associated with each of the one or more tickets associated with the one or more software;
e. determining an adjustment factor based on the weight corresponding each of the one or more predefined parameters associated with the one or more software;
f. determining adjusted ticket-units for the one or more software based on the net ticket-units and the adjustment factor;
g. determining productivity of each team of the one or more teams for the predefined time period based on the adjusted ticket-units and the number of FTEs associated with each team; and
h. generating the overall productivity of the organization based on a statistical analysis of the productivity of each team.

20. The computer program product according to claim 17, wherein the computer readable program code further performs storing at least one of the number of FTEs of the organization, the one or more tickets, the predefined ticket-unit associated with each of the one or more tickets, the one or more predefined parameters, the weight corresponding to each of the one or more predefined parameters, the number of FTEs associated with the one or more teams, the overall productivity of the organization, and the productivity of each team.
